(19) United States
(12) Patent Application Publication
(10) Pub. No.: US 2014/0037045 A1
(43) Pub. Date: Feb. 6, 2014

(54) DUAL ENERGY CT SCANNER

(71) Applicants: Ehud Dafni, Caesarea (IL); David Ruimi, Ganot Hadar (IL); Olga Shapiro, Haifa (IL)

(72) Inventors: Ehud Dafni, Caesarea (IL); David Ruimi, Ganot Hadar (IL); Olga Shapiro, Haifa (IL)

(73) Assignee: Arineta Ltd., Caesarea (IL)

(21) Appl. No.: 14/110,459

(22) PCT Filed: Apr. 4, 2012
(86) PCT No.: PCT/IL12/50123

§ 371 Date: Oct. 8, 2013

Related U.S. Application Data
(60) Provisional application No. 61/516,763, filed on Apr. 8, 2011.

(51) Int. Cl. G01T 1/16; G01N 23/04

(52) U.S. Cl. CPC G01T 1/16; G01N 23/046
USPC 378/5; 250/394; 378/4

(57) ABSTRACT

A dual energy CT scanner includes an X ray source generating an X-ray beam, a stacked detector array for detecting radiation from the X-ray beam, the stacked detector array including a first layer of detectors and a second layer of detectors, wherein a packing density of detectors in at least a portion of the first layer is different than a packing density of detectors in a corresponding portion of the second layer, a data acquisition unit for sampling data from the detectors in the first and second layer; and an image reconstruction unit for reconstructing an image from data acquired from at least one layer of the stacked detector array.

### RELATED APPLICATION/S

This application claims the benefit of priority under 35 USC 119(e) of U.S. Provisional Patent Application No. 61/516,763 filed Apr. 8, 2011, the contents of which is incorporated herein by reference in its entirety.

### FIELD OF THE INVENTION

The present invention, in some embodiments thereof, relates to Computerized Tomography (CT) and, more particularly, but not exclusively, to dual-energy CT scanners.

### BACKGROUND OF THE INVENTION

Computerized Tomography (CT) scanners produce images of an object by reconstruction of X-ray attenuation data acquired over multiple view angles. Typically, cross sectional images are constructed by back projecting the view data received from the CT detector over the multiple views. Typically, X-ray sources of wide energy spectrum are used and the CT images are representations of the energy-averaged X-ray attenuation coefficient at each image pixel, referred to as a CT number. CT numbers provides information regarding density of the scanned object. Material of the object can sometimes but not always be identified and/or distinguished from other material based on CT numbers. For example, in medical imaging, bone tissue comprising calcium may be represented by CT numbers that are similar to CT numbers representing blood vessel filled with iodine based contrast agent but different than CT numbers representing soft tissue.

Multi-slice, multi-row and/or cone beam CT scanners include a two-dimensional detector array for simultaneous acquisition of multiple slice data and/or volumetric data. Typically, the two-dimensional detector array includes a plurality of rows disposed parallel to a scanner rotation plane and a plurality of columns disposed perpendicular to the rows along a direction parallel to a scanner rotation axis.

U.S. Pat. No. 8,111,804 entitled “Graded Resolution Field of View CT Scanner,” assigned to Arineta Ltd., the content of which is incorporated herein by reference discloses a cone beam CT scanner including a detector array that has at least one high resolution region in which detectors are packed with a high packing density and at least one low resolution region in which detectors are packed with a low packing density. An X-ray radiation shielding plate is used to attenuate X-rays impinging on the at least one low resolution region. A processor processes attenuation data acquired with the detector array and calibrates data acquired from a shielded low-resolution region so that it can be compared with data acquired from a non-shielded high-resolution region.

Dual-energy CT measures X-ray attenuation of an object over two different photon energy ranges and is typically used to determine material composition of an object. The technique is based on the observation that different materials have a different spectral dependence of the attenuation. By acquiring data over different energy ranges, e.g. lower energy X-rays and higher energy X-rays, density as well as effective atomic number of a material may be determined. Dual energy CT is used in both medical imaging and in homeland security industry to improve imaging and to determine material composition of objects imaged. In the homeland security industry, dual energy X-ray is used for screening baggage and cargo for contraband, explosives and illicit material as well for identifying contents of objects for transportation.

There are several known methods of producing dual energy X-rays imaging and conducting dual energy analysis. In one form, two or more detectors are used, one behind the other, and a filter is optionally placed between the detectors. One detector receives one energy range, and the other detector receives a second energy range due to the absorption in the first detector and the optional filter. Alternately, an energy discriminating detector can be used to separate energies, such as a cadmium zinc telluride (CZT) detector used in single photon counting mode. Another approach commonly used is to vary the end output energy of the X-ray source, so that the X-ray source alternatively emits two or more X-ray energy ranges. Yet another approach is to use more than one X-ray tube, and each X-ray tube emits one or more energy ranges.

U.S. Pat. No. 4,247,774 entitled “Simultaneous dual-energy computer assisted tomography,” the content of which is incorporated herein by reference discloses a dual-energy detector system for use in computer assisted tomography employing two cooperating detectors, one behind the other. The front detector responds primarily to low-energy photons, allowing most high-energy photons to pass through. The back detector that lies behind the front detector detects the remaining photons. The two detectors can be shaped to be partially overlapped such that some of the x-rays pass through both. There is disclosed that a 6 mm CaF₂ crystal is used for the front detector, a thicker NaI crystal is used for the back detector.

U.S. Pat. No. 7,968,853 entitled “Double decker detector for spectral CT,” the contents of which is incorporated herein by reference, describes a radiation detector including a two-dimensional array of first scintillators and a two-dimensional array of second scintillators. The two-dimensional array of first scintillators is disposed to face an X-ray source, convert lower-energy radiation into visible light and transmit higher energy radiation. The two-dimensional array of second scintillators is disposed adjacent the first scintillators and distally from the x-ray source, and converts the transmitted higher energy radiation into visible light. The array is associated with a first and a second array of light sensitive elements, each light sensitive element of the array coupled to a side face of a scintillator element. The scintillators are disclosed to be formed from one of Zinc Selenide (ZnSe), Yttrium Aluminum Garnet (YAG), Cadmium Tungstate (CdWO₄), and Gadolinium Oxy Sulfide (GOS).

### SUMMARY OF THE INVENTION

According to some embodiments of the present invention, there is provided a dual energy CT scanner with a stacked detector array that is tuned to provide a improved signal output level and/or resolution is specific portions of the stacked detector array. According to some embodiments of the present invention, the stacked detector array includes section with different packing density of detectors and/or is formed with detectors having active areas of different sizes, e.g. different active sizes. According to some embodiments of the present invention, active size and/or packing density of the detectors are tuned to provide a desired level of signal output and/or resolution in defined areas on the stacked detector array. Optionally, absorbency and/or thickness of a detector are additionally tuned to provide a desired output.

According to some embodiments of the present invention, an active size and packing density of detectors in one layer of the stacked detector array is larger or smaller than an active size and/or packing density of detectors in another layer of the stacked detector array. According to some embodiments of the preset invention, the stacked detector array additionally includes variations in packing density and/or active sizes of detectors over a single layer of the detector array. According to some embodiments of the present invention, packing density and/or active size of a detector in a particular layer of the stack and/or in defined locations in a layer of the detector array is selected responsive to a resolution and/or statistics desired in a particular layer of the stack and/or in defined location in the layer.

According to an aspect of some embodiments of the present invention, the dual energy CT scanner includes a data matching and/or re-sampling unit for matching resolution of data obtained from with different packing densities and to produce a CT image and information regarding material composition of displayed objects from the data acquired.

According to an aspect of some embodiments of the present invention there is provided a stacked detector array for dual energy CT scanner including a first layer of detectors and a second layer of detectors, wherein a packing density of detectors in at least a portion of the first layer is different than a packing density of detectors in a corresponding portion of the second layer.

Optionally, the detectors in the first layer are disposed proximal to a source of X ray beam and the detectors in the second layer are adjacent the detectors in the first layer distal from the X-ray beam and wherein the packing density of the detectors in at least the portion of the first layer is less than the packing density of the detectors in at least the corresponding portion of the second layer.

Optionally, a ratio between an active area of a detector in at least the portion of the first layer and an active area of a detector in at least the corresponding portion of the second layer is an integer.

Optionally, all the detectors in at least one of the first and second layers have a uniform active area.

Optionally, the packing density of the detectors in at least the corresponding portion of the second layer is at least twice the packing density of the detectors in at least the portion of the first layer.

Optionally, a packing density of detectors in a first portion of the second layer is greater than a packing density of detectors in a second portion of the second layer.

Optionally, an active area covered by the first layer is less than an active area covered by the second layer.

Optionally, the stacked detector array is a two-dimensional array.

Optionally, the detectors in at least the portion of the first layer are operative to detect a lower X-ray energy range than the energy range detected by the detectors in at least the corresponding portion of the second layer.

Optionally, the detectors in at least the portion of the first layer are adapted to absorb X-ray radiation less efficiently than the detectors in at least the corresponding portion of the second layer.

Optionally, the detectors in any of the first and second layers are scintillator detectors.

Optionally, the detectors in any one of the first and second layers are constructed from any one of ZnSe, CdWO4, CsI, GOS, Y3A15O12:Ce, Lu3A15O12:Ce, BGO or modifications thereof.

Optionally, the stacked detector array includes a radiation absorbing filter between the first and second layer.

According to an aspect of some embodiments of the present invention there is provided a dual energy CT scanner including an X ray source generating an X-ray beam, a stacked detector array for detecting radiation from the X-ray beam, the stacked detector array including a first layer of detectors and a second layer of detectors, wherein a packing density of detectors in at least a portion of the first layer is different than a packing density of detectors in a corresponding portion of the second layer, a data acquisition unit for sampling data from the detectors in the first and second layer, and an image reconstruction unit for reconstructing an image from data acquired from at least one layer of the stacked detector array.

Optionally, the detectors in the first layer are disposed proximal to a source of X ray beam and the detectors in the second layer are adjacent the detectors in the first layer distal from the X-ray beam and wherein the packing density of the detectors in at least the portion of the first layer is less than the packing density of the detectors in at least the corresponding portion of the second layer.

Optionally, a ratio between an active area of a detector in at least the portion of the first layer and an active area of a detector in at least the corresponding portion of the second layer is an integer.

Optionally, all the detectors in at least one of the first layer and the second layer have a uniform active area.

Optionally, an active area covered by the first layer is less than an active area covered by the second layer.

Optionally, the active area covered by the first layer is off centered with respect to the active area covered by the second layer.

Optionally, the image reconstruction unit is operable to reconstruct images from data acquired over at least 360 degrees from the first layer and from data acquired over less than 360 degrees from the second layer.

Optionally, the stacked detector array is a two-dimensional array.

Optionally, the detectors in at least the portion of the first layer are operative to detect a lower X-ray energy range of the X-ray beam as compared to an X-ray energy range detected by the corresponding portion of the detectors in the second layer.

Optionally, the dual energy CT scanner includes an X-ray radiation filter between the first and second layer.

Optionally, a material composition detection unit for determining material composition based on data acquired from both the first and second layer.

Optionally, the dual energy CT scanner includes a re-sampling unit for matching a resolution obtained from the first layer of the detectors to a resolution obtained from the second layer of the detectors.

Optionally, the re-sampling unit is operative to perform re-sampling of data acquired from at least one of the first and second layer to provide corresponding data in the first and second layer.

Optionally, the re-sampling unit is operative to down-sample data acquired from the second layer.

Optionally, the re-sampling unit is operative to up-sample data acquired from the in at least one portion of the first layer.

According to an aspect of some embodiments of the present invention there is provided a method for dual energy CT scanning, the method including acquiring data from a stacked detector array including a first and second layer of detectors, wherein a packing density of detectors in at least a portion of the first layer is different than a packing density of detectors in a corresponding portion of the second layer, reconstructing image data from data acquired in any of the first and second layer, and determining a material composition based on the acquired data from first and second layers.

Optionally, the detectors in the first layer are disposed proximal to a source of X ray beam and the detectors in the second layer are adjacent the detectors in the first layer distal from the X-ray beam and wherein a packing density of detectors in a first portion of the second layer is greater than a packing density of detectors in a second portion of the second layer.

Optionally, a ratio between an active area of a detector in at least the portion of the first layer and an active area of a detector in the corresponding portion of the second layer is an integer value.

Optionally, the method includes re-sampling data acquired from at least the portion of the first layer so that it corresponds to data acquired from the corresponding portion in the second layer.

According to an aspect of some embodiments of the present invention there is provided a dual energy CT scanner including an X ray source generating an X-ray beam, a stacked detector array for detecting radiation from the X-ray beam, the stacked detector array including a first layer of detectors and a second layer of detectors wherein an extent of an active area covered by the first layer is different than an extent of an active area covered by the second layer, a data acquisition unit for sampling data from the detectors in the first and second layer, and an image reconstruction unit for reconstructing an image from data acquired from at least one layer of the stacked detector array.

Optionally, the packing density of detectors in at least the portion of the first layer is different than the packing density of detectors in the corresponding portion of the second layer.

Optionally, an active area covered by the first layer is off centered with respect to an active area covered by the second layer.

Optionally, the image reconstruction unit is operable to reconstruct images from data acquired over at least 360 degrees from the first layer and from data acquired from the second layer over less than 360 degrees.

Optionally, the dual energy CT scanner includes a material composition detection unit for determining material composition based on data acquired from active areas of the first and second layers that overlap.

Optionally, the dual energy CT scanner includes a radiation shield adapted to attenuate the radiation of the X-ray beam over an active area covered by only one of the first layer and the second layer of the detectors.

Optionally, the stacked detector array is a two-dimensional array.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are simplified schematic diagrams of a front and side view of a known dual energy CT scanner including a two dimensional stacked detector array;

FIGS. 2A, 2B and 2C are simplified schematic diagrams of exemplary stacked detector arrays including detectors with different active sizes in different layers of the stack, in accordance with some embodiments of the present invention;

FIGS. 3A and 3B are simplified schematic diagrams of exemplary stacked detector arrays including back mounted photodiodes, in accordance with some embodiments of the present invention;

FIGS. 4A and 4B are simplified schematic diagrams of a top and side view of an exemplary two dimensional stacked detector array including detectors with different active sizes in one layer of the stack, in accordance with some embodiments of the present invention;

FIGS. 5A and 5B are simplified schematic diagrams of exemplary detector arrays including different sized top and bottom layers, in accordance with some embodiments of the present invention;

FIG. 6 is a simplified flow chart of an exemplary method for generating image data and material composition data with data acquired from a stacked detector array in accordance with some embodiments of the present invention;

FIG. 7 is a simplified flow chart of an exemplary method for generating an image and for determining material composition in one or more regions in the image, both with data acquired from a stacked detector array in accordance with some embodiments of the present invention; and

FIG. 8 is a simplified block diagram of an exemplary dual energy CT scanner with a stacked detector array in accordance with some embodiments of the present invention.

### DESCRIPTION OF SPECIFIC EMBODIMENTS OF THE INVENTION

The present invention, in some embodiments thereof, relates to Computerized Tomography (CT) and, more particularly, but not exclusively, to dual-energy CT scanners.

One drawback of known dual energy CT scanners including stacked detectors is the large number of detection channels required to obtain a CT number for each of the lower energy X-ray detectors and for each of the higher energy X-ray detectors, each wired to dedicated electronic readout. Another drawback of CT scanners including stacked detectors is the reduced output level obtained from each layer of the stack as compared to an output level that can be obtained from a single layer detector. For a given photon flux provided by the X-ray source, the quantity of photons absorbed by one layer of the stack is at the expense of the quantity absorbed by another layer of the stack. When using detectors having a relatively small surface area, the statistics for at least one of the layers may at times reach a critically low level. Although, an output level from each detector can be strengthened by increasing a surface area occupied by each detector this would come at the often high expense of reduced packing density and reduced resolution.

The present inventors have found that the above mentioned drawbacks of dual energy CT scanners can be reduced by forming detector arrays with detectors that occupy variable sized surface areas and/or have different active sizes. According to some embodiments of the present invention, there is provided a dual energy CT scanner including stacked detector array with a first layer formed from detectors having a first active size, stacked over a layer formed from detectors having a second active size that is different than the first active size. In some exemplary embodiments, detectors in one layer are sized to cover a larger sensing surface area than detectors in another layer. In some exemplary embodiments, the stacked detector array is a two-dimensional stacked detector array including rows extending parallel to a scanner rotation plane and columns extending perpendicular to the rows along a direction parallel to a scanner rotation axis.

According to some embodiments of the present invention, larger area detectors are used for a layer that is typically less absorbent so that signal strength can be improved and smaller area detectors are used for a layer that is typically more absorbent to maintain a desired resolution for that layer. The present inventors have found that by increasing surface area of detectors in a lower absorbent layer and maintaining the surface area of detectors in the higher absorbent layer, statistics obtained from the less absorbent layer may be improved, while a resolution obtained from the higher absorbent material may maintained. In addition, by increasing the surface area of detectors in the lower absorbent layer, the number of detectors required in that layer is reduced together the amount of hardware and processing power typically required for operating that layer. Optionally, increasing an active size of a detector in one layer provides for decreasing an active size of detectors in another layer without appreciably increasing the hardware and/or processing power required to operate the CT scanner.

According to some embodiments of the present invention there is provided a dual energy CT scanner including a stacked detector array, where at least one layer of the stack is formed from detectors with different active sizes, e.g. occupying different sized surface areas in the array. According to some embodiments of the present invention, a layer includes small detectors, e.g. detectors with a smaller active area, in a central area of the layer and includes larger detectors in peripheral regions of the array. Typically, the central area of the array is defined to detect attenuation from a region of interest (ROI) and the peripheral portions are defined detect attenuation in areas surround the ROI. Optionally, in addition to varying active sizes of detectors in a first layer (or second layer), the stacked detector array includes detectors in the second layer (or first layer) that are either smaller or larger than the detectors in the first layer (or second layer). Optionally, using larger detectors in a portion of one layer also reduces the number of detectors required and thereby cost and complexity of the CT scanner. Optionally, using larger detectors in a portion of a layer provides for increasing the number of detectors and/or packing density in another portion of the stacked detector without appreciable increasing the amount of hardware and processing power required for operating the CT scanner and/or cost of the CT scanner.

According to some embodiments of the present invention, there is provided a dual energy CT scanner including a stacked detector array with layers that covers different sized surface areas. According to some embodiments of the present invention, the dual energy CT scanner scans a defined portion of a field of view (FOV) with a stacked detector array and scans an additional portion of the FOV with a single layer detector array. In some exemplary embodiments, the stacked detector array covers a portion of a FOV corresponding to a ROI and the single layer detector array covers a peripheral portion of a FOV, one or more portions outside the ROI. Optionally, a layer for absorbing lower energy X-rays is stacked over a portion, e.g. a central portion of a larger layer for absorbing higher energy X-ray. Optionally, the first and second detector arrays are formed from different sized detectors. Optionally, the first and/or top detector array is formed from detectors that are larger, e.g. cover a larger surface area than the detectors used to form the second and/or bottom detector array.

Typically, CT numbers are generated from attenuation data obtained from at least one layer, e.g. a layer absorbing the high energy X-rays while material composition is derived from attenuation data obtained from both the first and second layer. Optionally, material composition is determined from raw data acquired from both layers or from CT numbers computed for each layer. In some exemplary embodiments, CT numbers and/or an image to be displayed is generated from a layer providing higher resolution attenuation data and/or including a denser array of detectors. Optionally, information regarding material composition is determined at a lower resolution and is superimposed on an image formed from the CT numbers. In some exemplary embodiments, the dual energy CT scanner includes a data re-sampling unit for adjusting resolution of the attenuation data from the different layers so that attenuation data from the different layers using one or more algorithms so that data from the different layers can be compared and/or superimposed. Optionally one or more averaging, bi-linear interpolation, decimating, and/or duplicating algorithms are used for down-sampling and/or up-sampling the attenuation data from one or more of the layers.

In some exemplary embodiments, information regarding material composition is only determined in one or more specific areas of interested detected on an image constructed from generated CT numbers. In some exemplary embodiments, a dual energy CT scanner processes an image constructed from attenuation data obtained from one layer to detect an area of interest on the image and then material composition is computed in the area of interested selected based on data acquired from both layers. Optionally, the CT scanner displays the image constructed from attenuation data obtained from one layer to a user and information regarding material composition in a selected area on the image is computed responsive to user selection.

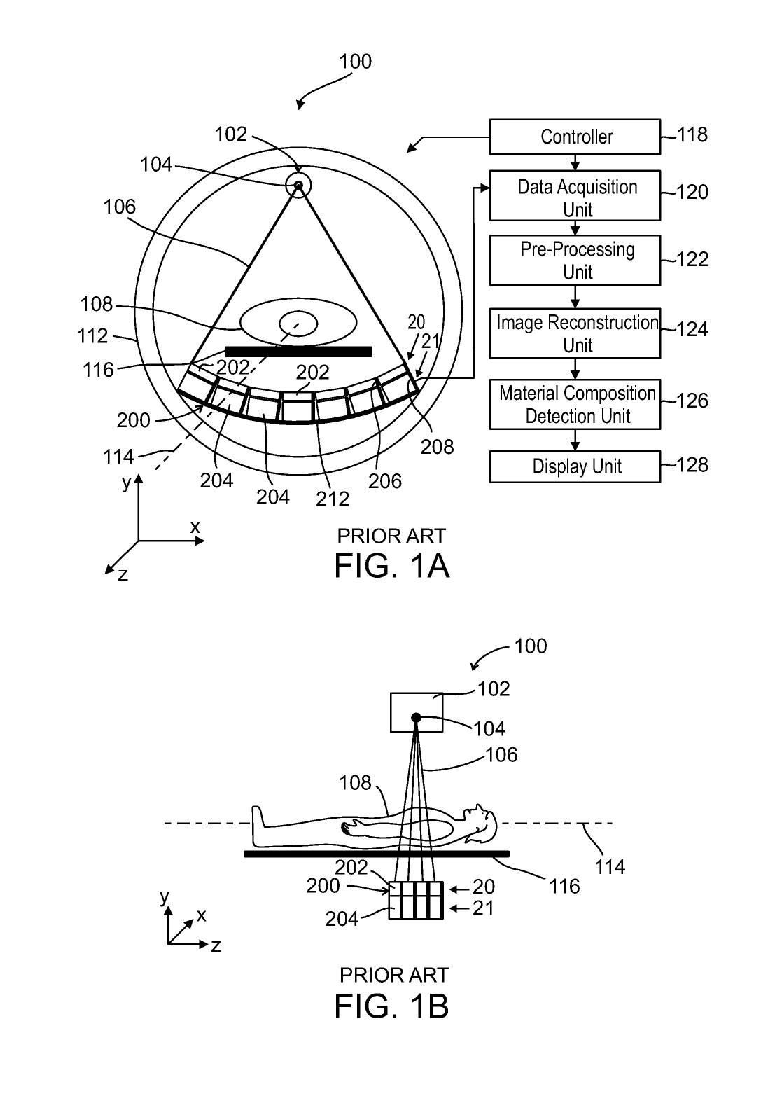

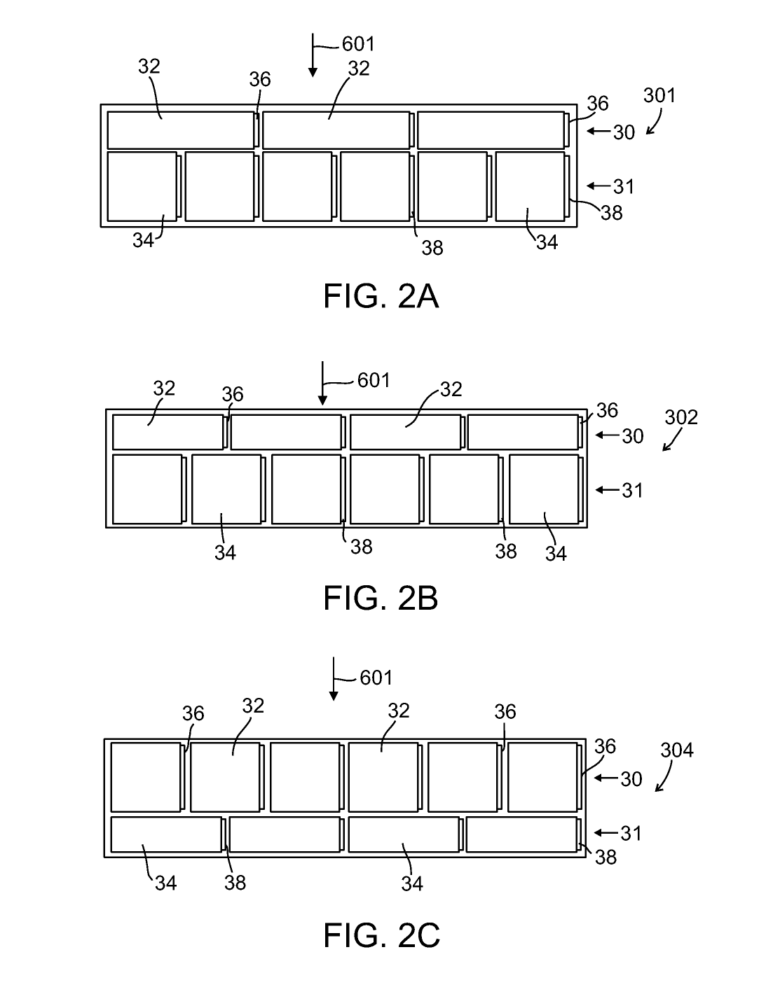

For purposes of better understanding some embodiments of the present invention, as illustrated in FIGS. 2-7 of the drawings, reference is first made to construction and operation of an exemplary dual energy CT scanner as illustrated in FIG. 1A and FIG. 1B. Some known dual energy CT scanners 100 include a single X-ray source 102 mounted on a frame 112 opposite a stacked array of detectors 200 also mounted on frame 112. A support 116 for supporting an object and/or subject 108 is positioned between X-ray source 102 and stacked detector array 200. During operation, X-ray source 102 generates an X-ray beam 106 that is emitted from a focal spot 104. X-ray beam 106 is directed toward stacked detector array 200 through subject 108 so that X-ray beam 106 is attenuated by subject 108 before impinging on stacked detector array 200. Typically, stacked detector 200 detect attention data over multiple view angles, as frame 112 rotates about a rotation axis 114 parallel to a Z axis. Stacked detector array 200 is a two dimensional stacked array including a plurality rows disposed parallel to a scanner rotation plane, parallel to an X-Y plane (FIG. 1A) and a plurality of columns disposed perpendicular to the rows along a direction parallel to a scanner rotation axis 114 (FIG. 1B). Dual energy CT scanners with different sized detector arrays are known in the art, e.g. CT scanner sold by Toshiba includes a detector array with 320 rows and about 900 columns.

Some known stacked detector arrays includes a first two dimensional layer 20 of scintillaor elements 202 for absorbing low energy X-rays of X-ray beam 106 and a second two dimensional layer 21 of scintillator elements 204 for absorbing high energy X-rays of X-ray beam 106. Each of elements 202 and elements 204 are sized to occupy a same sized surface area on stacked detector array 200 and are positioned on the layers so that elements 202 are aligned with elements 204.

Typically, elements 202 for absorbing low energy X-rays are disposed on top layer 20 of the stack proximal to X-ray source 102 and elements 204 for absorbing high energy X-rays are disposed adjacent to elements 202 distally from X-ray source 102 on bottom layer 21. Detectors and/or elements 202 are known to be formed from approximately 1 mm thick ZnSe scintillators and detectors and/or elements 204 are known to be formed from approximately 2 mm thick CdWO₄ scintillator. Typically, between 30-40% of the photons from beam 106 are absorbed by elements 202 and the remaining 60-70% of the photons are absorbed by elements 204. Each of elements 202 and 204 are optically coupled to a photodiode element 206 and 208, respectively. Typically, each of scintillator elements 202 and 204 are coated with light reflector material. Typically, the arrays of detectors are mounted on support substrate 212.

Typically, positioning of subject 108 with respect to focal spot 104 and operation of dual energy CT scanner 100 is controlled by controller 118. Attenuation data from stacked detector array 200 is acquired by data acquisition unit 120. Typically data is acquired from each of elements 202 and elements 204 and pre-processed with pre-processing unit 122. Typically an image reconstruction unit 124 generates CT numbers for imaging based on the pre-processed data obtained from pre-processing unit 122. In some exemplary embodiments, material composition detection unit 126 process the CT numbers generated by image reconstruction unit 124 for each of the layers and generates images of material composition. Optionally, data acquired from both layers are further pre-processed to generate material composition sensitive pre-processed data. Optionally, image reconstruction unit 124 reconstructs material composition sensitive images based on the material composition sensitive pre-processed data. Optionally CT numbers are only generated for one of the layers, e.g. the high energy layer. Since each of elements 202 and elements 204 occupy a same sized surface area on stacked detector array 200 and are positioned on the layers so that they are aligned with each other, data acquired from the different elements and the different layers can be easily compared. Optionally, further image processing is performed to integrate information obtained from each of material composition detection unit 126 and image reconstruction unit 124 on a display unit 128. Typically, processed data is displayed to a user on display unit 128. Optionally information regarding material composition is used to enhance a portion of a reconstructed image associated with a defined material composition property. Optionally, information regarding material composition is used to remove display of an object having a defined material composition property. Optionally, material composition of an object is identified with the information regarding material composition.

Other parts of the detector array are not shown for clarity. In some known dual energy CT scanners, stacked detector array 200 has a curved arc shaped as shown in FIG. 1A. In other known CT scanners the stacked detector array is flat.

Reference is now made to FIGS. 2A, 2B and 2C showing simplified schematic diagrams of exemplary stacked detector arrays including detectors with different active sizes in different layers of the stack, in accordance with some embodiments of the present invention. According to some embodiments of the present invention, a stacked detector array 301 and/or 302 includes a top and/or first layer 30 of detectors 32 and a bottom and/or second layer 31 of detectors 34. The terms top and bottom refer to radiation direction 601 so that radiation emitted in direction 601 is first received by top layer 30 and subsequently received by bottom layer 31. Typically, each detector 32 and 34 are optically coupled to photodiode elements 36 and 38, respectively, and are coated with light reflecting material 310 on one or more of its sides. According to some embodiments of the present invention, top layer including detectors 32 measure a low energy range of an X-ray spectrum, e.g. an X-ray spectrum of an X-ray beam 106 and bottom layer including detectors 34 measure a high energy range of the X-ray spectrum.

According to some embodiments of the present invention, detectors 32 are sized to have a larger active area and lower packing density than detectors 34. It is noted that although only the frontal view of the array is shown, each of detectors 32 and 34 may include a square active area so that the dimensions of the detectors in a side view is similar to the dimensions shown in the frontal view. Alternatively, rectangular shaped detectors can be used and an active area of detectors 32 can be enlarged in one or more dimensions of detectors 32. Optionally, a ratio between an active size of detector 32 and 34 is an integer number as shown in FIG. 2A. Alternatively the ratio between an active size of detector 32 and 34 is a non-integer number as shown in FIG. 2B. Optionally, all detectors 32 are sized to have a uniform active area and all detectors 34 are sized to have another uniform active area.

Typically, by increasing the active areas of detectors 32, a signal level and/or output level acquired from the detectors is increased. Typically, the increase in signal level is proportional to an increase in surface area of the active area of the detector. For example, if a length and width of detector 32 is doubled (FIG. 2A), both a surface area of an active area of detector 32 and a signal level is increased by a factor of 4. Although a packing density and therefore resolution provided by layer 30 is reduced responsive to increasing an active area of detectors 32, the reduction in resolution may be of a less significant than the increase in signal output. In some exemplary embodiments, by increasing active areas of detectors 32 and maintaining the active areas of detectors 34 a resolution for determining material composition of an object and/or subject is reduced but a resolution of a CT image formed from density data of high density layer 31, e.g. obtained from detectors 34 is maintained.

According to some embodiments of the present invention, improved signal output obtained by increasing an active area of detector 32 can be used to reduce a thickness of detector 32 in radial direction 601 so that a percentage of photons passing to detectors 34 can be increased. Typically, size and thickness of detectors 302 are defined based on a material composition of the detector and/or design requirements of the CT scanner. Optionally, all detectors 32 are sized to have a uniform thickness and all detectors 34 are sized to have a uniform thickness. Optionally, detectors 32 are ZnSe scintillators elements having a thickness between 0.7-1 mm in radial direction 601 and detectors 34 are CdWO₄ or GOS scintillator elements with thickness 1-2 mm.

Alternatively, signal output of detectors 32 is strengthened by increasing a thickness of detector 32 in radial direction 601. Optionally, reduction in signal output of detectors 34 due to the thicker detector 32 can be compensated for by increasing the active area of detectors 34 in bottom layer 31.

It is noted that although FIGS. 2A-2D only show a one dimensional stacked detector array, detector arrays 301, 302, 303 and 304 may optionally represent one row and/or column of a two dimensional array.

In exemplary embodiment, in array 301 there are 64 rows of detectors 34 with pitch of 1 mm in the column direction, and 688 detectors 34 in each row at pitch of 1.3 mm. Optionally, 32 rows of detectors elements 32 are provided with pitches of 2 mm and 2.6 mm, respectively. Optionally, when using such a construction, the total number of detection channels in the array is 55,040, compared to 88,064 channels in a CT scanner where the upper and lower layers of detectors are at the same pitch.

In another exemplary embodiment, detectors 34 have twice the pitch of detectors 32 in one dimension (e.g. row dimension) but a different pitch compared to detectors 34 in the other dimension (e.g. column direction), including possibly same pitch for elements 32 and 34 in the other dimension (e.g. column direction).

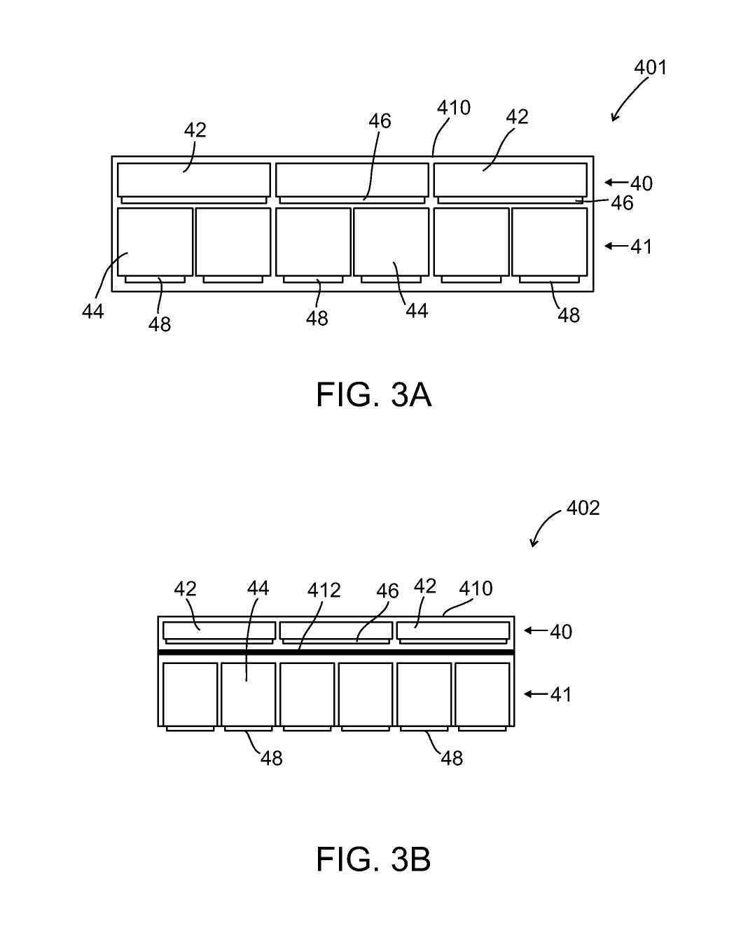

Reference is now made FIGS. 3A and 3B showing simplified schematic diagrams of exemplary stacked detector arrays including back illuminated photodiodes, in accordance with some embodiments of the present invention. According to some embodiments of the present invention, a stacked detector array includes a top layer 40 of detectors 42 and a bottom layer 41 of detector 44, each detector 42 and 44 optically coupled to photodiode elements 46 and 48, respectively, and coated on one or more surfaces with light reflecting material 410. Typically, the surface coupled to the photodiode is not coated. According to some embodiments of the present invention, photodiode elements 46 and 48 are back illuminated photodiodes arrays. Alternatively, in some exemplary embodiments, front illuminated photo diodes arrays, e.g. with front to back feed through as is known in the art can be used. According to some embodiments of the present invention, detector array 402 additionally includes a layer of absorbing filter 412 disposed between detectors 42 and detectors 44. Optionally, filter 412 improves the energy separation between the top level and bottom level by absorbing low energy radiation in a range intended to be absorbed by top layer 40 but was not absorbed. Optionally, filter 412 is formed from a 0.2 mm thick layer of cooper, although other filtering materials and/or different thickness can be used as well.

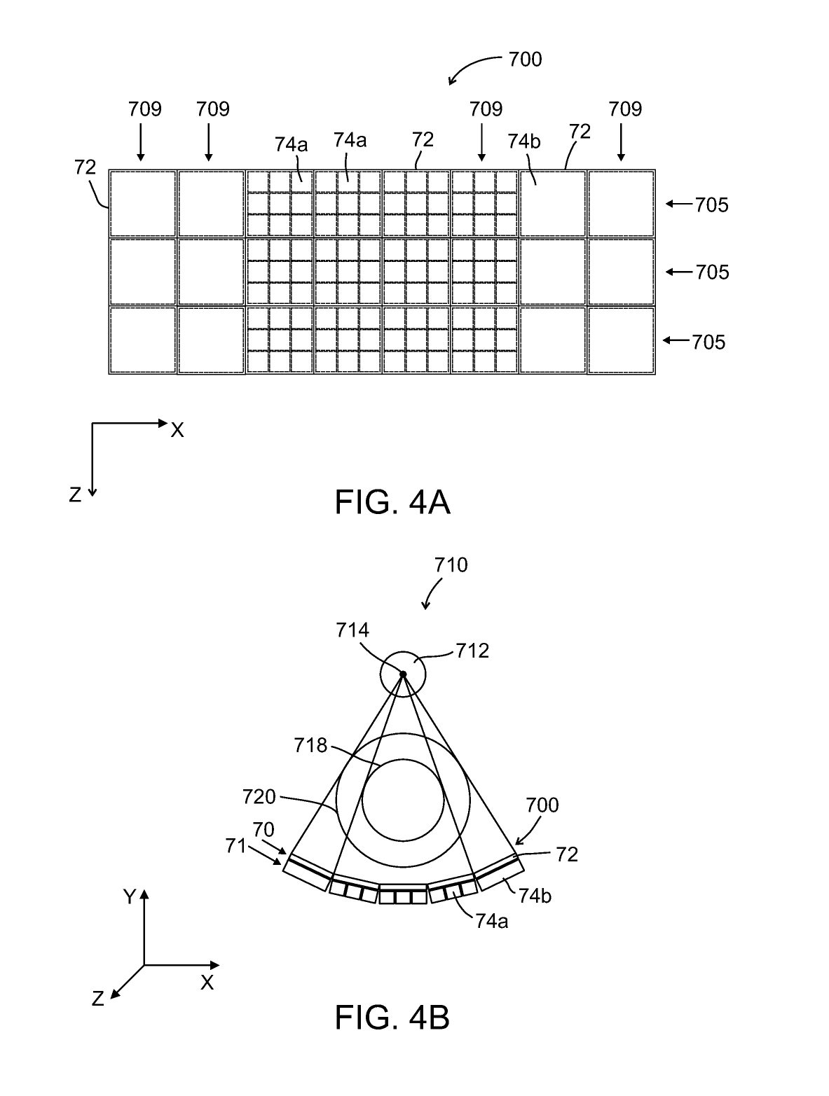

Reference is now made to FIGS. 4A and 4B showing simplified schematic diagrams of a top view of an exemplary two dimensional stacked detector array including detectors with different active sizes in one layer of the stack, and a side view of the detector within a schematic diagram of the CT scanner, in accordance with some embodiments of the present invention. According to some embodiments of the present invention, a CT scanner 710 (FIG. 4B) includes a two dimensional stacked detector array 700 having a top layer 70 formed with detectors 72 and a bottom layer 71 formed with detectors 74, e.g. including detectors 74a and 74b. It is noted that in FIG. 4A detectors 72 are represented by solid lines and detectors 74a and 74b are represented by dashed lines.

According to some embodiments of the present invention, detectors 72 absorb a low energy range of an X ray spectrum emitted by X-ray source 712 at focal point 714 and detectors 74a and 74b forming bottom layer 71 absorb a high energy range of the X ray spectrum. According to some embodiments of the present invention, detectors 74a in bottom layer 71 have a smaller active area and provide a higher packing density than detectors 74b also in bottom layer 71. Optionally, a portion of an X-beam directed toward detectors 74b is attenuated with a shield to reduce exposure of a subject in a low resolution area.

In exemplary embodiments, detectors 74a and 74b are aligned with detectors 72, e.g. a center to center pitch of each of detectors 74a and 74b is an integer multiple of a center to center pitch of detector 72 in both the X and Z direction. Alternately, a center to center pitch of one or more of detectors 74a and 74b may be a non integer multiple of the center to center pitch of detector 72 in one or more of directions X and Z so that the detectors 74a and 74b are not aligned with the detectors 72.

Typically, detectors 74a are aligned with detectors 74b, e.g. a center to center pitch of each of detectors 74a is an integer multiple of a center to center pitch of detector 74b in both the X and Z direction. Alternatively, detectors 74a and 74b are not aligned and the center to center pitch of detectors 74a is a non integer multiple of the center to center pitch of detector 74b in one or more of directions X and Z.

Typically, smaller active area elements 74a packed with a relatively high packing density extend over an area detecting attenuation from a ROI 718 within a larger FOV 720 and larger active area detectors 74b packed with a relatively low packing density extend over an area detecting attenuation from a region outside ROI 718, e.g. and within region of detection 720. Typically, ROI 718 is centered about a rotational axis of CT scanner 710 and elements 74a extend over a central region of one or more rows 705 of array 700. In some exemplary embodiments, detectors 72 have a uniform active area that corresponds to an active area of detector 74b. Alternatively, detectors 72 can have an active area that is larger than an active area of detectors 74b. In some exemplary embodiments, detectors 72 extending over an area detecting attenuation from ROI 718 are replaced with a plurality of smaller detectors. In some exemplary embodiments, variation in packing density is also introduced in a column direction 709. Optionally, detectors 74a are disposed in a central region of one or more columns 709 and detectors 74b are disposed in a peripheral region of one or more of columns 709.

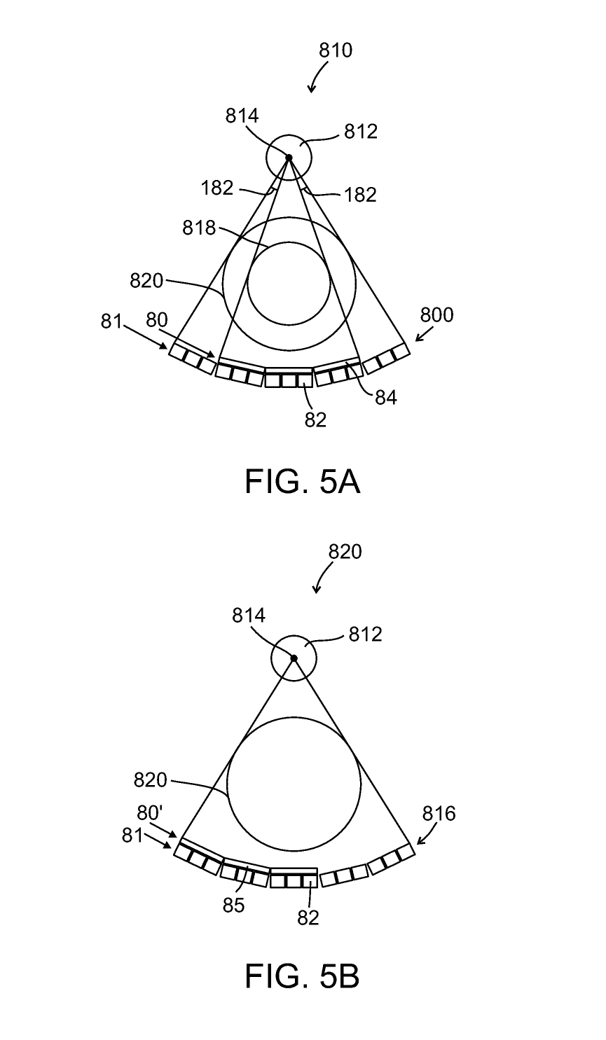

Reference is now made to FIGS. 5A and 5B showing simplified diagrams of exemplary detector arrays within a CT scanner including different sized top and bottom layers, in accordance with some embodiments of the present invention. Referring now to FIG. 5A, according to some embodiments of the present invention a CT scanner 810 includes an X-ray source 812 that emits radiation from focal point 814 that is directed to a stacked detector array 800. According to some embodiments of the present invention, stacked detector array 800 includes a top layer 80 formed with detectors 84 that extend over an area generally corresponding to a ROI 818 and also includes a bottom layer 81 formed with detectors 82 that extends over a larger FOV 820 that typically includes and surrounds ROI 818. Optionally, CT scanner 810 includes one or more radiation shields 182 for attenuating radiation from X-ray source 812 that is directed toward a portion of stacked detector array 800 including only one layer of detectors, e.g. a portion of detector array 800 including detectors 82 but not including detectors 84. In some exemplary embodiments, detectors 84 are sized to have a different, e.g. larger active area than active areas of detectors 82. According to some embodiments of the present invention, top layer 80 is centered with respect to bottom layer 81 in at least one dimension.

According to some exemplary embodiments, scanner 800 generates high resolution images of CT numbers for FOV 820 with data acquired from detectors 82 and in addition determines material composition in ROI 818 based on data obtained from both detectors 82 and 84. Typically, scanner 800 determines material composition with a lower resolution as compared to the resolution of the images of CT numbers since detectors 84 provide a lower resolution than detectors 82 used to generate the CT image. Alternatively, detectors 84 are replaced with smaller sized detectors and material composition is determined at a same resolution as an image generated by with data acquired from detectors 82. In some exemplary embodiments, detector array 800 is a two dimensional stacked array. Optionally, top layer 80 formed with detectors 84 extend over only a portion of columns forming the two dimensional array. Typically, top layer 80 is centered with respect to bottom layer 81. Optionally, a portion of an X-beam directed toward detectors 84 in a region with a single layer is attenuated with a shield to reduce exposure of a subject outside ROI 818.

Referring now to FIG. 5B, according to some embodiments of the present invention, a detector array 816 includes bottom layer 81 formed with detectors 82 covering a full detection area and a top layer 80′ formed with detectors 85 covering a smaller area that is off centered with respect to bottom layer 81. Optionally, detectors 85 cover at least half of detector array 816 starting from one side of detector array 816. According to some embodiments of the present invention, CT images are generated using detectors 82 when data is acquired over less than 360 degree rotation of the CT scanner. In some exemplary embodiments, when data is acquired over at least 360 degree rotation of the CT scanner, data from elements 85 is used to reconstruct an image for an entire scanned volume 820 and image data generated from elements 85 can be combined with image data from detectors 82 to obtain material composition information. Optionally, material composition information is determined from reconstructed images and/or pre-processed data obtained from detectors 82 and 85.

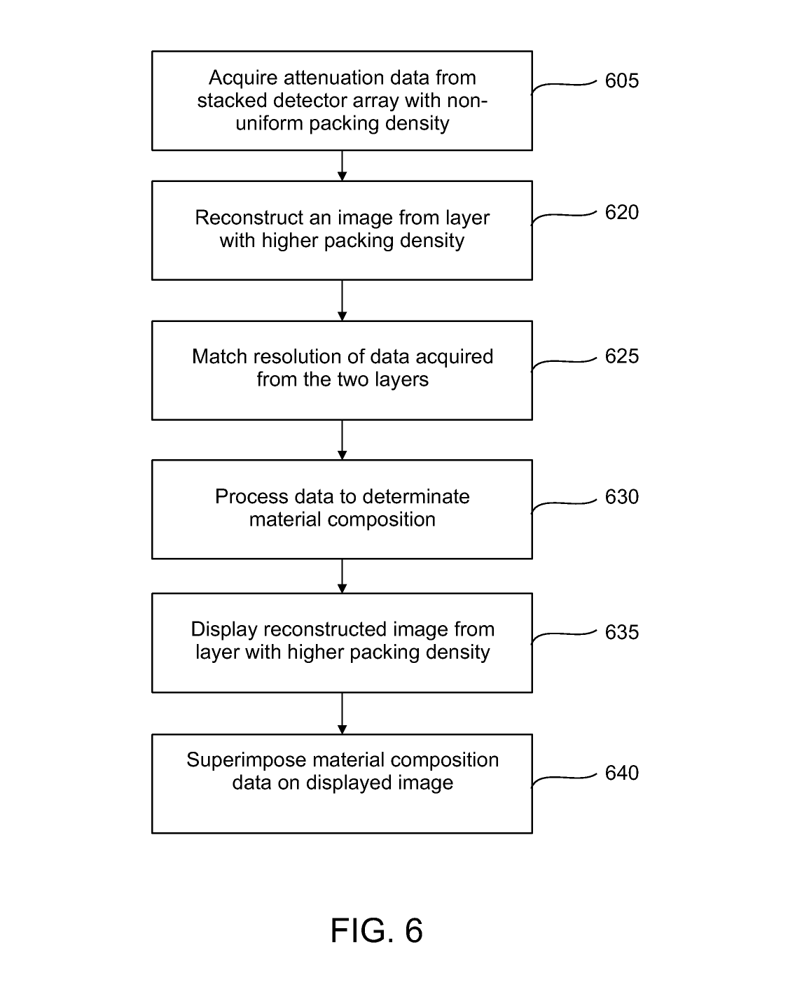

Reference is now made to FIG. 6 showing a simplified flow chart of an exemplary method for generating image data and material composition data with data acquired from a stacked detector array in accordance with some embodiments of the present invention. According to some embodiments of the present invention, during operation of a dual energy scanner, attenuation data from a stacked detector array with non-uniform packing density is acquired (block 605). Typically data is acquired from each detector in each of the two layers. Typically, a layer constructed with a higher packing density is used to reconstruct an image for display (block 620). Typically, a high energy absorbing bottom layer is used to reconstruct an image for display, although the opposite situation can also take place. Optionally, an image is reconstructed for each of the layers. Optionally, the images for each layer are combined by weight averaging the CT numbers obtained from each of the layers to obtain a combined image. Typically, better statistics and contrast resolution can be achieved by combining images and/or image data from the different layers.

Optionally, information regarding material composition is determined by comparing data obtained from the different layers, e.g. pre-processed data. According to some embodiments of the present invention, when comparing the pre-process data to determine material composition, resolution obtained from the layers is matched, e.g. artificially using one or more algorithms so that the data from the different layers can be compared and/or analyzed (block 625). In some exemplary embodiments, matching is achieved by down-sampling data obtained from the layer having the higher packing density. Optionally down-sampling is performed using decimation, interpolation, filtering and/or the like. Optionally, matching is achieved by up-sampling the data obtained from the layer having the lower packing density. In some exemplary embodiments, if detectors from the different layers are not aligned, data is further processed to resample data from one or more of the layers so that the data is matched.

In some exemplary embodiments, in an event that one of the layers includes variations in packing density, e.g. as shown in FIGS. 4A-4B data obtained is re-sampled to obtain a uniform set of data using one or more algorithms known in the art. Optionally data acquired from a portion of the array with lower packing density is up-sampled prior to reconstructing the image from that layer. Optionally, up-sampling is achieved by duplication and/or other known methods in the art. In some exemplary embodiments, in an event that the low and high density regions of the array are not aligned, bi-linear interpolation and/or the like is additionally used to resample the data in the low density regions as required.

According to some embodiments of the present invention, matched image data for the two layers is processed to determine material composition (block 630). Alternatively, material composition is determined by comparing the two sets of image data, e.g. CT numbers and re-sampling of the data from the different layers is not required.

Typically, the image reconstructed from the high density layer is displayed (block 635). In some exemplary embodiments, material composition information is superimposed on the displayed image using for example color code or other graphic presentations (block 640).

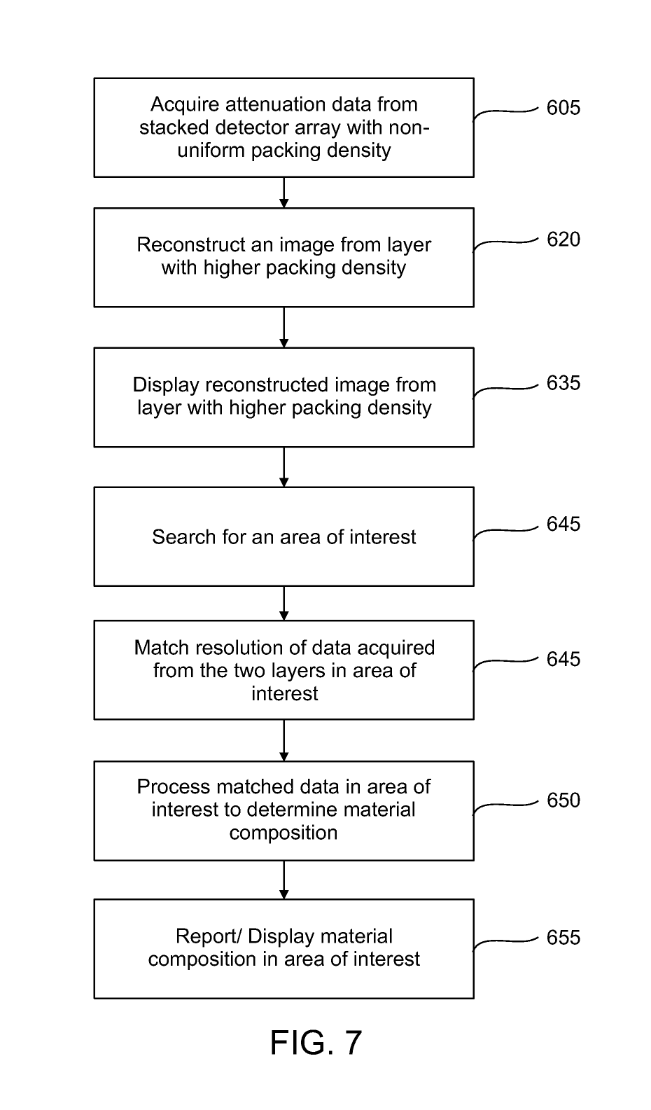

Reference is now made to FIG. 7 showing a simplified flow chart of an exemplary method for generating an image and for determining material composition in one or more regions in the image, both with data acquired from a stacked detector array in accordance with some embodiments of the present invention. According to some embodiments of the present invention, during operation of a dual energy scanner, attenuation data from a stacked detector array with non-uniform packing density is acquired (block 605). Typically data is acquired from each detector in each of the two layers. Typically, a layer constructed with a higher packing density is used to reconstruct an image for display (block 620). Typically, a high energy absorbing bottom layer is used to reconstruct an image for display, although the opposite situation can also take place. Optionally, an image is reconstructed for each of the layers and the images are combined by weight averaging the CT numbers obtained from each of the layers. Optionally, data acquired from each of the layers are combined and image reconstruction is performed on the combined data. Typically, data from at least one layer is re-sampled so that the data from the different layers can be combined.

According to some embodiments of the present invention, the reconstructed image is displayed to a user (block 635) for inspection. In some exemplary embodiments, the reconstructed image is processed to detect one or more areas of interest in which information regarding material composition is desired (block 645). Optionally and/or additionally, a user selects one or more areas of interest on the displayed image. In some exemplary luggage screening application, the high resolution image is used to detect potential locations on the image displaying concealed weapons, sharp objects, explosives and/or drugs based on user inspection and/or image processing.

According to some embodiments of the present invention, one or more selected areas on the image are further examined using data obtained from both layers of the stacked detector. According to some embodiments of the present invention, pre-processed data obtained from one or more layers in an area of the array corresponding to selected areas of interest are re-sampled and/or matched (block 645) so that the data from the two layers can be compared and material composition in the selected areas can be determined (block 650). Optionally downsizing is performed using decimation, interpolation, filtering and/or the like. In some exemplary embodiments, matching is achieved by down-sampling data obtained from the layer having the higher packing density. Optionally, matching is achieved by up-sampling the data obtained from the layer having the lower packing density. Optionally, material composition is determined based on image data, e.g. CT numbers generated for each of the layers. Typically, matching and/or re-sampling of the data are not required when material composition is determined based on image data. In some exemplary embodiments, material composition information is superimposed on the displayed image using for example color code or other graphic presentations and/or is otherwise reported (block 655)

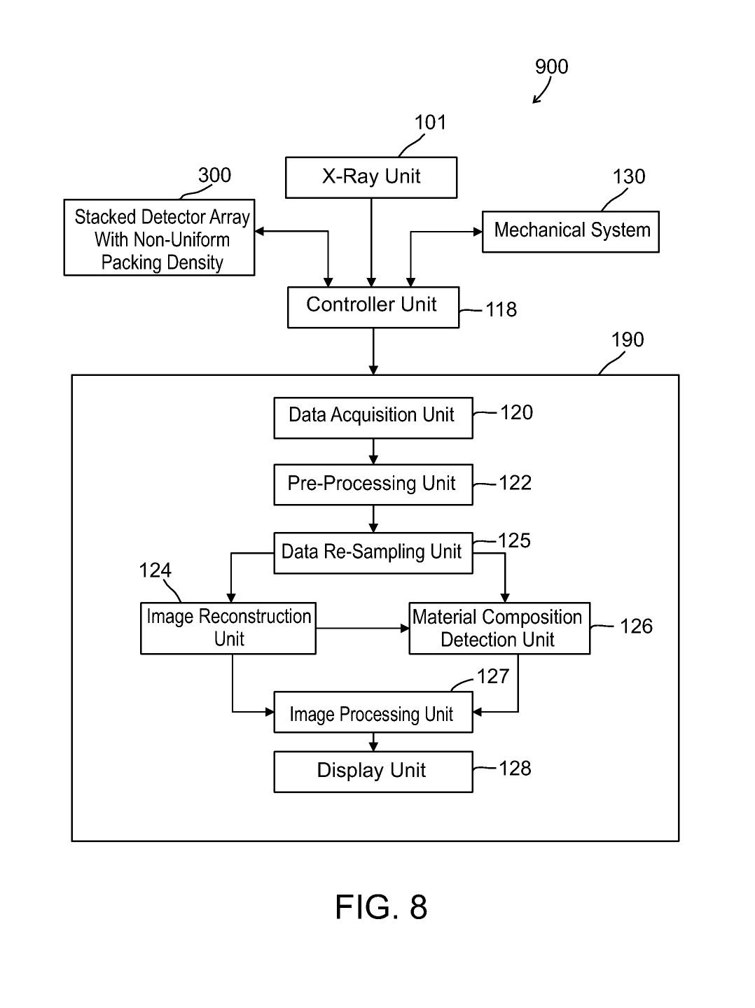

Reference is now made to FIG. 8 showing a simplified block diagram of an exemplary dual energy CT scanner with a stacked detector array in accordance with some embodiments of the present invention. Typically, CT scanner 900 is a single or multi-slice scanner that includes an X-ray unit 101 for generating and emitting radiation toward a stacked detector array 300 including non-uniform packing density of the detectors in the array. Optionally, X-ray unit includes one or more X-ray tubes adapted for forming a focal spot, one or more collimator blades to direct an orientation of the cone beam, shielding for reducing X-ray intensity in a portion of the beam.

Typically, stacked detector array 300 is a two-dimensional stacked detector array. In some exemplary embodiments, stacked detector array 300 includes a top layer of detectors for absorbing a lower energy range of X-ray radiation and a lower layer of detectors for absorbing a lower energy range of X-ray radiation. In some exemplary embodiments, the top layer stacked detector array 300 is constructed with a lower packing density of the detectors as compared to the bottom layer of stacked detector array 300. Optionally, variations in packing density are also included in a single layer. Optionally, the top layer of array 300 extends over only a portion of the bottom layer of array 300.

Typically, X-ray unit 101 and stacked detector array 300 are mounted on a rotatable frame and a support for a subject and/or object to be scanned, e.g. that is optionally movable is positioned between X-ray unit 101 and stacked detector array 300 so that radiation emitted from X-ray unit 101 is attenuated by the subject and/or object prior to being detected with stacked detector array 300. The rotating frame and support can be generally considered as part of a mechanical system 130 of CT scanner 900. Typically, operation of X-ray unit 101, mechanical system 130, and/or stacked detector array 300 are controlled by one or more controllers that are typically in communication and can generally be referred to as control unit 118. Typically, control unit 118 also controls operation of processing and display unit 190.

According to some embodiments of the present invention, data acquisition unit 120 acquires attention data stacked detector array 300 over multiple view angles for each detector in stacked detector array 300. Typically, data acquired by data acquisition unit 120 is pre-processed with pre-processing unit 122. Typically, pre-processed data is used by image reconstruction unit 124 to generate CT numbers and/or reconstruct images from data acquired from one or both layers of stacked detector array 300. According to some embodiments of the present invention, material composition detection unit 126 determining material composition of a scanned object and/or subject directly from data obtained from pre-pre-processing unit 122. Optionally, material composition detection unit 126 determines material composition based on CT numbers reconstructed with image reconstruction unit 124. Typically, material composition detection unit 126 compares and process data originating from both layers of stacked detector 300 so that material composition can be determined.

According to some embodiments of the present invention, a data matching unit 125 re-samples, up-samples, down-samples and/or processes data obtained from different portions of stacked detector array 300 having different packing densities. In some exemplary embodiments, data matching unit 125 matches data resolution of a high packing density layer with a data resolution of a lower packing density layer. Optionally, when the detectors in the two layers are not aligned further processing is performed to match the data obtained from the two layers. In some exemplary embodiments, data matching unit 125 matches a resolution of data from a portion of a layer including a high packing density with resolution of data from the portion of a layer including a low packing density with resolution. Typically, data matching unit 125 manipulates raw data acquired by data acquisition unit 120.

In some exemplary embodiments, CT numbers and/or other data generated by image reconstruction unit 124 and/or material composition detection unit is further processed by an image processing unit 122. Optionally, image processing unit 127 superimposes data from image reconstruction unit 124 and material composition detection unit 126 to form a single image that is displayed on display unit 128. Typically, display unit 128 additionally provides for reporting additional information determined from one or more of image reconstruction unit 124 and material composition detection unit 126.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

1. A stacked detector array for dual energy CT scanner comprising:
a first layer of detectors and a second layer of detectors, wherein a packing density of detectors in at least a portion of the first layer is different than a packing density of detectors in a corresponding portion of the second layer.

2. The stacked detector array of claim 1, wherein the detectors in the first layer are disposed proximal to a source of X ray beam and the detectors in the second layer are adjacent the detectors in the first layer distal from the X-ray beam and wherein the packing density of the detectors in at least the portion of the first layer is less than the packing density of the detectors in at least the corresponding portion of the second layer.

3. The stacked detector array of claim 1, wherein a ratio between an active area of a detector in at least the portion of the first layer and an active area of a detector in at least the corresponding portion of the second layer is an integer.

4. The stacked detector array of claim 1, wherein all the detectors in at least one of the first and second layers have a uniform active area.

5. (canceled)

6. The stacked detector array of claim 1, wherein a packing density of detectors in a first portion of the second layer is greater than a packing density of detectors in a second portion of the second layer.

7. The stacked detector array of claim 1, wherein an active area covered by the first layer is less than an active area covered by the second layer.

8. The stacked detector array of claim 1, wherein the stacked detector array is a two-dimensional array.

9. The stacked detector array of claim 1, wherein the detectors in at least the portion of the first layer are operative to detect a lower X-ray energy range than the energy range detected by the detectors in at least the corresponding portion of the second layer.

10. (canceled)

11. The stacked detector array of claim 1, wherein the detectors in any of the first and second layers are scintillator detectors.

12. (canceled)

13. The stacked detector array of claim 1, comprising a radiation absorbing filter between the first and second layer.

14. A dual energy CT scanner comprising:
an X ray source generating an X-ray beam;
a stacked detector array for detecting radiation from the X-ray beam, the stacked detector array including a first layer of detectors and a second layer of detectors, wherein a packing density of detectors in at least a portion of the first layer is different than a packing density of detectors in a corresponding portion of the second layer;
a data acquisition unit for sampling data from the detectors in the first and second layer; and
an image reconstruction unit for reconstructing an image from data acquired from at least one layer of the stacked detector array.

15. The dual energy CT scanner of claim 14, wherein the detectors in the first layer are disposed proximal to a source of X ray beam and the detectors in the second layer are adjacent the detectors in the first layer distal from the X-ray beam and wherein the packing density of the detectors in at least the portion of the first layer is less than the packing density of the detectors in at least the corresponding portion of the second layer.

16-17. (canceled)

18. The dual energy CT scanner of claim 14, wherein an active area covered by the first layer is less than an active area covered by the second layer.

19. The dual energy CT scanner of claim 18, wherein the active area covered by the first layer is off centered with respect to the active area covered by the second layer.

20. The dual energy CT scanner of claim 15, wherein the image reconstruction unit is operable to reconstruct images from data acquired over at least 360 degree from the first layer and from data acquired over less than 360 degree from the second layer.

21. (canceled)

22. The dual energy CT scanner of claim 14, wherein the detectors in at least the portion of the first layer are operative to detect a lower X-ray energy range of the X-ray beam as compared to an X-ray energy range detected by the corresponding portion of the detectors in the second layer.

23. The dual energy CT scanner of claim 14, comprising an X-ray radiation filter between the first and second layer.

24. The dual energy CT scanner of claim 14, comprising a material composition detection unit for determining material composition based on data acquired from both the first and second layer.

25. The dual energy CT scanner of claim 14, comprising a re-sampling unit for matching a resolution obtained from the first layer of the detectors to a resolution obtained from the second layer of the detectors.

26. The dual energy CT scanner of claim 25, wherein the re-sampling unit is operative to perform re-sampling of data acquired from at least one of the first and second layer to provide corresponding data in the first and second layer.

27. The dual energy CT scanner of claim 25, wherein the re-sampling unit is operative to perform at least one of down-sampling data acquired from the second layer and up-sampling data acquired from the in at least one portion of the first layer.

28. (canceled)

29. A method for dual energy CT scanning, the method comprising:
acquiring data from a stacked detector array including a first and second layer of detectors, wherein a packing density of detectors in at least a portion of the first layer is different than a packing density of detectors in a corresponding portion of the second layer;
reconstructing image data from data acquired in any of the first and second layer; and
determining a material composition based on the acquired data from first and second layers.

30. The method of claim 29, wherein the detectors in the first layer are disposed proximal to a source of X ray beam and the detectors in the second layer are adjacent the detectors in the first layer distal from the X-ray beam and wherein a packing density of detectors in a first portion of the second layer is greater than a packing density of detectors in a second portion of the second layer.

31. (canceled)

32. The method of claim 29, comprising re-sampling data acquired from at least the portion of the first layer so that it corresponds to data acquired from the corresponding portion in the second layer.

33-39. (canceled)
